(19) United States
(12) Patent Application Publication
(10) Pub. No.: US 2006/0106694 A1
(43) Pub. Date: May 18, 2006

(54) Transfer of deposit and debit subscriptions using a single financial account

(75) Inventors: Michael P. Carlson, Austin, TX (US); Herman Rodriguez, Austin, TX (US)

Correspondence Address: Greg Goshorn, P.C., 2110 W. Slaughter lane, SUITE 115-119, AUSTIN, TX, 78748, US

(73) Assignee: INTERNATIONAL BUSINESS MACHINES CORPORATION, ARMONK, NY (US)

(21) Appl. No.: 10/988,468

(22) Filed: Nov. 12, 2004

(51) Int. Cl. G06Q 40/00

(52) U.S. Cl. 705/35

(57) ABSTRACT

Provided is a method for transferring automatic debit and deposit transactions from an account at one financial institution to another account at another financial institution. When the account is opened, the old financial institution forwards the request for payment or deposit to the new financial institution. The new institution sends an address correction to the party that automatically submits the automatic transaction, identifying both the old and new accounts. If the transaction is a payment, the payment originates from the new account at the new bank and is transmitted to the original destination. If the transaction is a deposit, the transaction originates from the original institution and is transmitted to the new account at the new institution.

### TECHNICAL FIELD

The present invention relates generally to a financial management system and, more specifically, to a method for transferring assets automatic deposit and debit transactions one financial institution to another.

### SUMMARY OF THE INVENTION

Provided is a method for transferring automatic debit and deposit transactions from one financial institution to another. Currently, when such a transfer occurs, the original transaction is canceled and the new transaction is initiated from scratch. The disclosed technique involves the establishment of a single, integrated account. Rather than multiple accounts, a bank customer is provided with a single, integrated financial account for all transactions. Different types of affected accounts include, but are not limited to, savings accounts, credit card accounts, automatic fund transfers, loan accounts and mortgage accounts. A balance of the integrated account is determined by withdrawals and deposits regardless of to which component of the integrated account a particular withdrawal or deposit corresponds. The balance of a specific integrated account can be positive, negative or equal to zero.

Automatic deposits and withdrawals are seamlessly transferred by the disclosed technique. When an integrated account is opened, the old bank or other financial institution forwards the request for payment or deposit to the new bank. The new bank then sends an address correction to the party that automatically submits the automatic transaction, identifying both the old and new account destinations. If the transaction is a payment, then the payment originates from the new account at the new bank and is transmitted to the original destination. If the transaction is a deposit, the transaction originates from the original institution and is transmitted to the new account at the new institution. If the balance of the new, integrated account is positive, interest is accrued on the integrated account. If the balance of the new, integrated account is negative, then interest is charged. The customer does not need to wait for all transactions to clear before the account can be transferred. In this manner, automatic transactions are transferred without the necessity of canceling and activating new requests.

### BRIEF DESCRIPTION OF THE DRAWING

A better understanding of the present invention can be obtained when the following detailed description of the disclosed embodiments is considered in conjunction with the following drawings, in which:

FIG. 1 is a block diagram of an exemplary financial institution that implements the claimed subject matter;

FIG. 2 is a block diagram of an exemplary customer account incorporating the disclosed techniques;

FIG. 3 is a block diagram of the logic necessary to implement the claimed subject matter;

FIG. 4 is a flowchart of an exemplary Transaction Processing process;

FIG. 5 is a flowchart of an exemplary Calculate Credit Rating process; and

FIG. 6 is a flowchart of an exemplary Transfer Account process.

### DETAILED DESCRIPTION OF THE FIGURES

Although described with particular reference to a bank, the claimed subject matter can be implemented in any financial management system in which multiple accounts corresponding to a single customer are administered. Those with skill in the financial arts will recognize that the disclosed embodiments have relevance to a wide variety of financial institutions in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

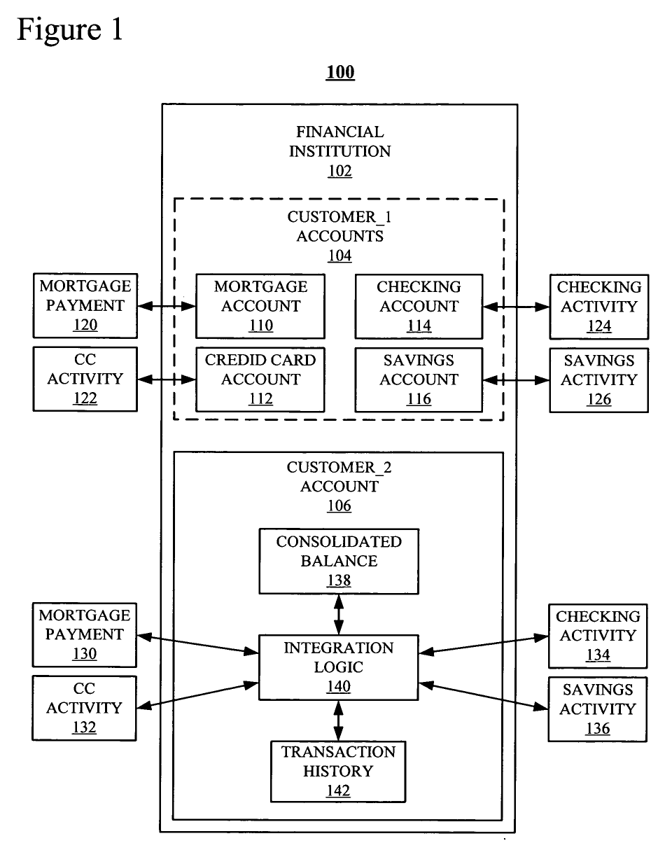

FIG. 1 is a block diagram of an exemplary financial institution 100 that implements the claimed subject matter. Institution 100, which for the sake of convenience is referred to throughout this description as a bank, is shown administering multiple accounts 104 corresponding to a particular customer, referred to as “customer_1,” (not shown). Customer_1 has a mortgage account 110, a credit card account 112, a checking account 114 and a savings account 116. Of course there are many other types of accounts to which the claimed subject matter is applicable. The accounts 110, 112, 114 and 116 are types of accounts typically available in many current financial institutions and are illustrated for comparison purposes. It should be noted that accounts 110, 112, 114, and 116 are stand-alone accounts, each of which correspond to a particular customer_1 and each have their own balance, interest rate (if applicable) and history. The dotted line of customer_1 accounts 104 indicates a relationship between a particular customer and accounts 110, 112, 114 and 116 without indicating that accounts themselves are otherwise related.

If customer_1 transmits a mortgage payment 120, the payment 120 affects a balance and history of mortgage account 110. If customer_1 makes a charge or a payment to a credit card, i.e. a credit card (CC) activity 122, then the balance and history of credit card account 112 is affected. In a similar fashion, a deposit or withdrawal from checking account 114 or saving account 116, generated by either a checking activity 124 or a savings activity 126, respectively, affects the corresponding account 114 or 116 accordingly.

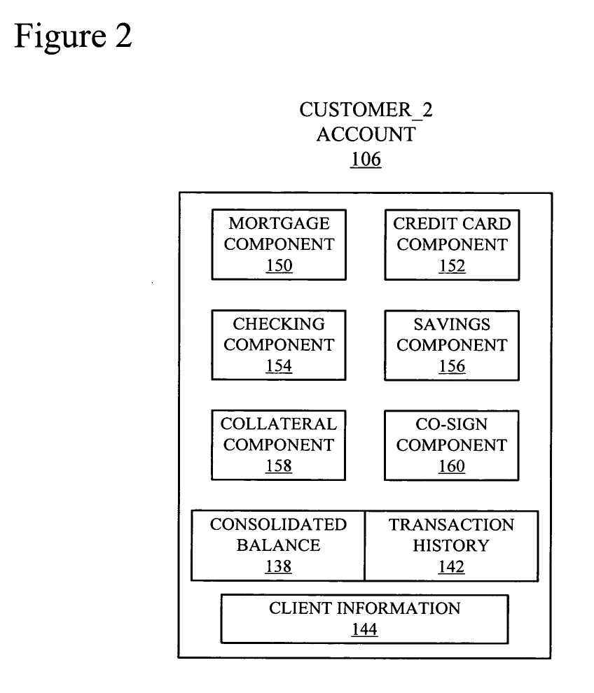

In contrast to stand-alone accounts 110, 112, 114 and 116 of customer_1, another customer, referred to as “customer_2,” (not shown) holds a customer_2 account 106, which is a single, integrated account according to the claimed subject matter. Customer_2 account 106 is described in more detail below in conjunction with FIG. 2.

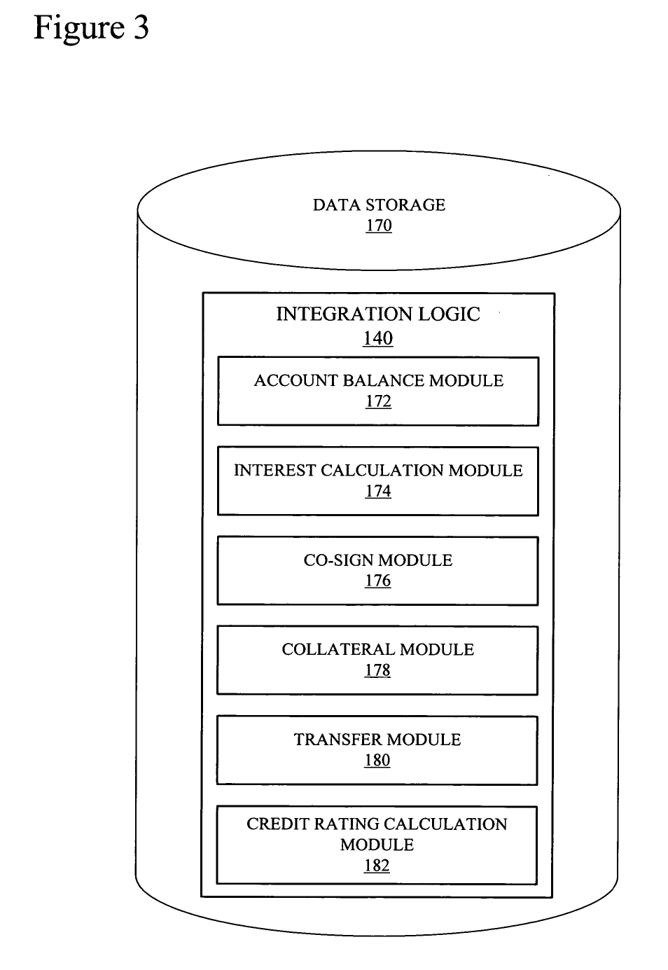

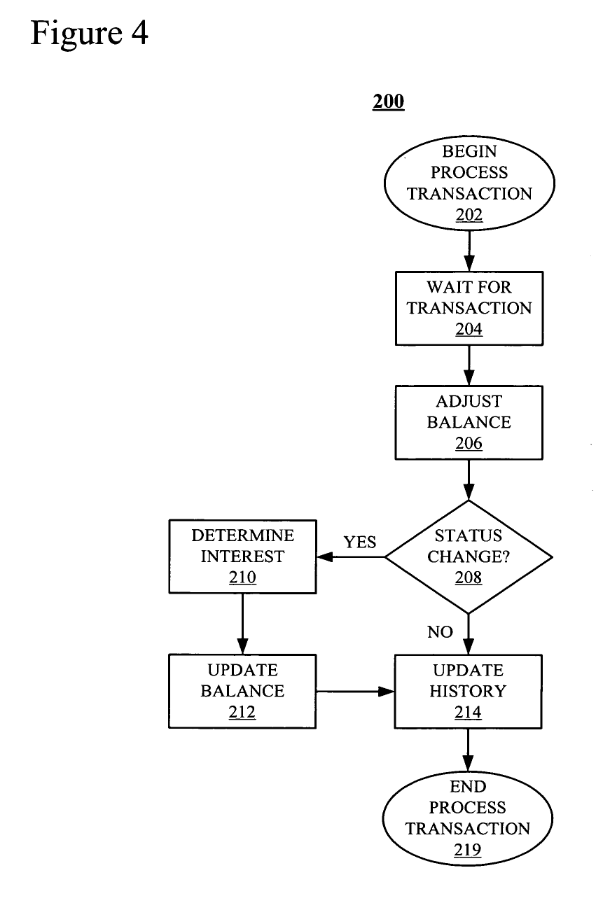

With respect to account 106, a mortgage payment 130, a credit card activity 132, a checking activity 134 and a savings activity 136 are all processed by an integration logic module 140. Integration logic module, or component, 140 is described in more detail below in conjunction with FIGS. 2 and 3. As explained below, integration logic 140, which processes activities 130, 132, 134 and 136 on behalf of account 106 is actually not a component of account 106. Rather, integration logic 140 is more correctly described as a component of a computing system (not shown) of financial institution 100 that administers account 106. In other words, integration logic 140 takes information associated with mortgage payment 130, credit card activity 132, checking activity 134 and savings activity 136 and updates both a consolidated balance 138 and a transaction history 142. Further, integration logic 140 typically administers account such as account 106 for many customers of financial institution 100. The process of updating consolidated balance 138 and transaction history 142 are described in more detail below in conjunction with FIG. 4.

It should be noted that standard accounts 110, 112, 114 and 116 and integrated account 106 are only representative of the accounts of financial institution 100. A typical financial institution such as institution 100 would have hundreds, and perhaps thousands, of customers and accounts.

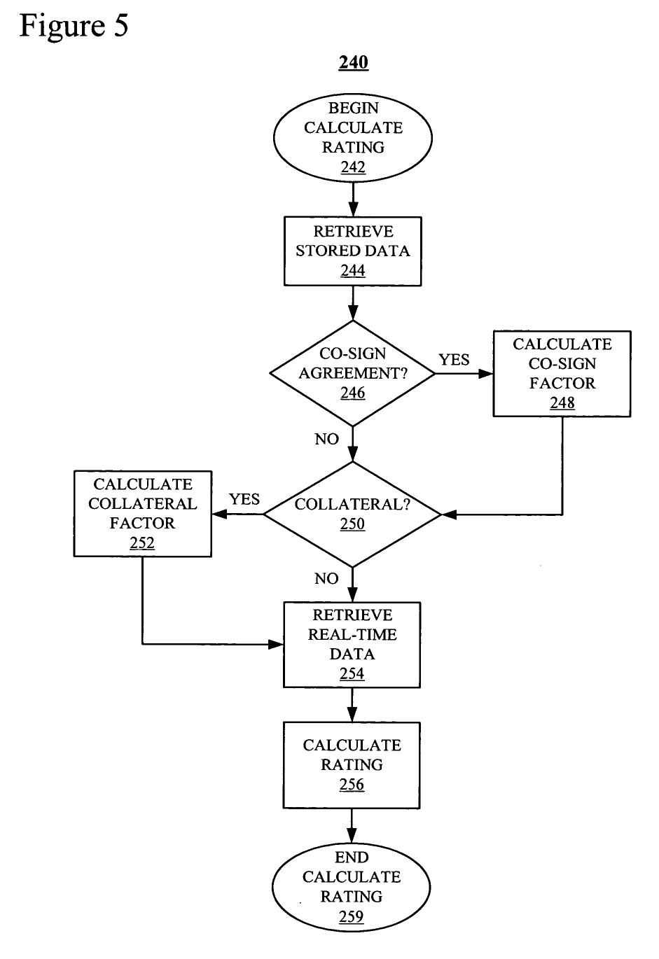

FIG. 2 is a block diagram of customer_2 account 106 (FIG. 1) in more detail. Account 106 includes a mortgage component 150, a credit card component 152, a checking component 154, a savings component 156, a collateral component 158 and a co-sign component 160. Components 150, 152, 154, 156, 158 and 160 store information necessary to separate consolidated balance 138 into corresponding component parts. For example, if customer_2 wants to view account 106 in a traditional sense, i.e. separate accounts for separate activities, customer_2 can download the stored information into a Personal Financial Management (PFM) system that parses the information and displays balance in a traditional format. The information stored in components 150, 152, 154, 156, 158 and 160 is also employed by a credit rating calculation module 182 (see FIG. 3) by means of a Credit Rating Process 240 (see FIG. 5) to calculate customer_2's credit rating.

Mortgage component 150 serves the purposes of a mortgage loan such as mortgage account 110 (FIG. 1). Credit card component 152 serves the purposes of a credit card account such as credit card account 112. Checking component 154 serves the purposes of a checking account such as checking account 114. Savings component 156 serves the purposes of a savings account such as savings account 116. Although collectively they serve the purposes of accounts 110, 112, 114 and 116, components 150, 152, 154 and 156 are not stand-alone accounts, but rather are a part of single, integrated account 106.

Consolidated balance 138 and transaction history 142, also part of integrated account 106, are first introduced above in conjunction with FIG. 1. Not illustrated in account 106, as explained in conjunction with FIG. 1, is integration logic 140, which is more conveniently considered part of the computing system that administers customer_2 account 106. Consolidated balance 138 is calculated based upon deposits and withdrawals presented to account 106. Examples of such deposits and withdrawals are activities 130, 132, 134 and 136 (FIG. 1). Balance 138 is calculated by integration logic 140 without regard for which activity 130, 132, 134 and 136 generated the deposit or withdrawal. A Client Information component 144 includes data relevant to customer_2 and the administration of account_2 106 such as, but not limited to, address, name change, billing dates, desired language and a currency denominations (if particular transfers require a currency exchange).

Integration logic 140 also updates transaction history 142 each time an activity such as activities 130, 132, 134 and 136 are performed and received by bank 100. Unlike balance 138, transaction history 142 retains a record of the source of a particular deposit or withdrawal. By employing the information stored in consolidates balance 138 and transaction history 142, financial institution 100 can ascertain a credit rating and the over-all level of activity for customer_2.

Collateral component 158 enables customer_2 to have reflected in consolidated balance 138 any collateral that financial institution 100 deems appropriate. For example, if customer_2 assigns as collateral real estate or other property to financial institution 100, then financial institution 100 can account for the property in collateral component 158, and thus ultimately in consolidated balance 138. Collateral component 158 may include a factor that assigns a value to the property based upon some percentage of the property's appraised value, a practice common in generally acceptable accounting principles. Another example of property handled within collateral component 158 is common stock. Collateral component 158 may include logic to have a current market value of the stock, and thus the value of consolidated balance 138, based upon a real-time stock quote, however the quote may be obtained.

Co-sign component 160 enable financial institution 100 to account for the liability represented by a loan or other type of agreement that customer_2 has guaranteed for another party. It should be noted that in typical financial accounts, such as that represented by customer_1's accounts 104 (FIG. 1), there is no straight forward way to account for the existence of co-sign obligations. Co-sign component 160 includes logic to evaluate the risk of a particular obligation based upon a real-time balance of the obligation and the credit-worthiness of the party who is benefiting from the guarantee so that the obligation can be reflected in consolidated component 138.

FIG. 3 is a block diagram of integration logic 140 of FIG. 1 in more detail. Logic 140 is illustrated stored on a data storage 170, which would be coupled to a suitable computing system (not shown). Data storage 170 also stores information corresponding to customer_2 account 106 (FIGS. 1 and 2). As stated above, integration logic 140 can be implemented in software, hardware, or a combination of software and hardware. The hardware portion can be implemented using specialized logic; the software portion can be stored in a memory such as data storage 170 and executed by a suitable instruction execution system such as a microprocessor (not shown), personal computer (PC) (not shown) or mainframe (not shown).

Integration logic 140 includes an account balance module 172, an interest calculation module 174, a co-sign module 176, a collateral module 178, a transfer module 180 and a credit rating calculation module 182. Account balance module 172 receives information related to deposits and withdrawals corresponding to activities such as activities 130, 132, 134 and 136 (FIG. 1) as well as, if applicable, information from modules 174, 176, 178 and 182 and uses that information to calculate and store consolidated balance 138 (FIGS. 1 and 2).

Interest calculation module 174 determines, based upon stored parameters (not shown) such as customer_2's credit rating, an amount of interest to periodically add to consolidated balance 138, if balance 138 is a positive value, and an amount of interest to periodically deduct form balance 138 if balance 138 is a negative value. Both a first interest rate, employed by integration logic 140 when balance 138 is a positive value, and a second interest rate, employed when is calculated by interest calculation module 174.

Interest calculation module 174 determines both the first interest rate and the second interest rate, both of which are periodically applied to balance 138 by account balance module 172, based upon, among other factors, a credit rating provided by credit rating calculation module 182. Credit rating module 182 is explained in more detail below. Other factors that may be employed by interest calculation module 174 include, but are not limited to, the current prime rate and other bench mark rates.

Co-sign module 176 determines a value to place upon any co-signing obligation of customer_2, depending of course upon whether or not such an agreement exists. The co-sign value is determined by such factors as the current balance of the obligation and a credit rating of the beneficiary of the co-signing agreement. The calculated co-sign value is used by account balance module 172 to determine a value for consolidated balance 138.

Collateral module 178 determines a value to place upon any collateral provided to financial institution by customer_2. For example, for purposes of affecting consolidated balance 138, improved real estate held for the long term may be only valued at eighty percent (80%) of the appraised value to account for fluctuations in the market. Unimproved real estate held for a short term may be valued at fifty percent (50%) of the appraised value. Collateral module 178 makes determinations as appropriate and provides this calculation to account balance module 172.

Transfer module 180 is employed if customer_1 decides to transfer account 106 to another institution. If the other institution does not have a system compatible with the claimed subject matter, then transfer module 180 is responsible for allocating consolidated balance 138 into discrete accounts corresponding to the accounts provided by the new institution. If the other institution does have a compatible system, then transfer module 180 is responsible for closing the account and providing the new institution with the necessary information, including consolidated balance 138, transaction history 142 and client information 144 (FIGS. 1 and 2). Other information includes information concerning any automatic deposits or withdrawals associated with account 106.

Finally, credit rating calculation module 182 is responsible for calculating on-demand a real-time credit rating for customer_2. Consolidated balance 138 and transaction history 142 are employed to perform the calculation. Information in transaction history 142 used in the calculation include, but is not limited to, the frequency of deposits and withdrawals. Other information that may be employed include frequency and type of changes to mortgage component 150 (FIG. 2), credit card component 152 (FIG. 2), checking component 154 (FIG. 2), savings component 156 (FIG. 2), collateral component 158 (FIG. 2) and co-sign component 160 (FIG. 2). Fluctuations in composite balance 138, including maximums and minimums, also are employed to calculate a credit rating in real-time.

FIG. 4 is a flowchart of an exemplary Transaction Processing process 200 that implements an aspect of the claimed subject matter. Process 200 starts in a “Begin Process Transaction” block 202 and proceeds immediately to a “Wait for Transaction” block 204. During block 204, process 300 is suspended until a transaction, i.e. a deposit or withdrawal, is entered against, in this example, customer_2 account 106 (FIGS. 1 and 2). When a transaction does occur, process 200 proceeds to an “Adjust Balance” block 206 during which account balance module 172 (FIG. 3) of integration logic 140 (FIGS. 1 and 3) updates consolidated balance 138 (FIGS. 1 and 2) based upon the received transaction. As mentioned above, the calculation of consolidated balance 138 does not depend upon the specific type of transaction, e.g., activity 130, 132, 134 or 136 (FIG. 1).

Process 200 then proceeds to a “Status Change?” block 208 during which process 200 determines whether the value of consolidated balance 138, which was updated in block 206, has changed from a positive to a negative or from a negative to a positive. If account 106 has changed, then process 200 proceeds to a “Determine Interest” block 210 during which interest calculation module 174 (FIG. 3) of integration logic 140 calculates the amount of interest to pay using consolidated balance 138. If balance 138 has changed from negative to positive, then module 174 calculates a first rate at which account 106 earns interest income. If balance 106 has changed from a positive to a negative, then module 174 determines a second rate at which account 106 is charged interest.

Once an interest rate has been calculated during block 210, control proceeds to an “Update Balance” block 212 during which process 200 updates consolidated balance 138 according to newly determined interest rate. Typically, interest charges and earnings are calculated at defined intervals such as at the end of each day, but, in the event of a change of status as determined during block 208, charges or earnings are calculated immediately. Control then proceeds to an “Update History” block 214 during which process 200 adds information corresponding to the transaction received in block 204 to transaction history 142 (FIGS. 1 and 2), including such data as the type of transaction, the amount of the transaction, the change of status detected in block 208, the resultant interest charges or earnings calculated in 210, and a historical record of consolidated balance 138.

If, in block 208, process 200 determines that there has not been a status change, then control proceeds to Update History block 214 during which process 200 updates transaction history 142 with information corresponding to the type and amount of the transaction received in block 204 and a historical record of consolidated balance 138. Once transaction history 142 has been updated, process 200 proceeds to an “End Process Transaction” block 219 in which process 200 is complete.

FIG. 5 is a flowchart of an exemplary Calculate Credit Rating process 240 that implements an aspect of the claimed subject matter and is executed by credit rating calculation module 182 (FIG. 2) of integration logic 140 (FIGS. 1 and 3). Process 240 starts in a “Begin Calculate Rating” block 242 and proceeds immediately to a “Retrieve Stored Data” block 244. During block 244, process 240 retrieves data stored in the components of account 106, e.g. mortgage component 150 (FIG. 2), credit card component 152 (FIG. 2), checking component 154 (FIG. 2), savings component 156 (FIG. 2), collateral component 158 (FIG. 2), co-sign component 160 (FIG. 2), consolidated balance 138 (FIGS. 1 and 2) and transaction history 142 (FIGS. 1 and 2).

Process 240 then proceeds to a “Co-sign Agreement?” block 246 during which process 240 determines, based upon information in co-sign component 160, whether or not account 106 includes any co-signed agreements that need to be factored into the credit rating calculation. If so, control proceeds to a “Calculate Co-sign Factor” block 248 during which process 240 determine the amount of obligation represented by the so-sign agreement(s) and a weighting factor to place upon the amount of liability. For example, if the beneficiary of a co-sign agreement has a great credit rating, then only a corresponding fifty percent (50%) of the obligation may be factored into the final credit rating calculation. On the other hand, if the beneficiary has a poor credit rating, ninety-five percent (95%) may be considered an appropriate weighting factor.

After the co-sign data and factors have been calculated during block 246 and, if in block 246, process 240 determines there are no co-sign agreements, then process 240 proceeds to a “Collateral?” block 250. During block 250, process 240 determines, based upon information stored in collateral component 158, whether or not account 106 includes any collateral that should be factored into the credit rating calculation. If so, control proceeds to a “Calculate Collateral Factor” block 252 during which process 240, in a fashion similar to the technique employed above in conjunction with Calculate Co-sign Factor” block 240, determines a percentage rate to apply to the value of the collateral for the purposes of the credit rating.

After the collateral data and factors have been calculated during block 252 and, if in block 250, process 240 determines there is no collateral associated with account 106, then process 240 proceeds to a “Retrieve Real-time Data” block 254. During block 254, process 240 gets various real-time data for use in calculating the net assets and liabilities associated with account 106. Examples of such data include, but are not limited to, current stock quotes that apply to common stock held as collateral and relevant interest rates such as the prime rate and current mortgage rates.

Finally, based upon the data collected during blocks 244, 246, 248, 250, 252 and 254, credit rating calculation module 182 produces a credit rating for, in this example, customer_2. Process 240 then proceeds to an “End Calculate Rating” block 259 in which processing is complete.

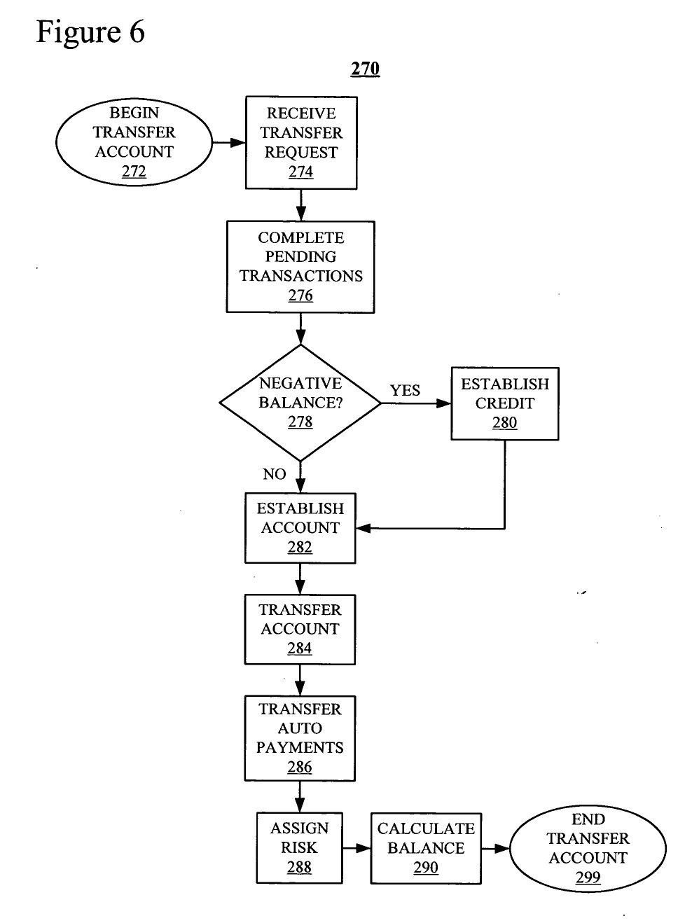

FIG. 6 is a flowchart of an exemplary Transfer Account process 270 portions of which are executed by transfer module 180 (FIG. 2) of integration logic 140 (FIGS. 1 and 3) and implements one aspect of the claimed subject matter. It should be noted that a number of the following blocks require action by both the old financial institution, in this example, financial institution 102 (FIG. 1), and the new institution, for the sake of simplicity simply called “institution_2.” Some blocks represent action taken by only one of the institutions and, in that case, the description will specify the institution that is acting.

Process 270 starts in a “Begin Transfer Account” block 272 and control proceeds immediately to a “Receive Transfer Request” block 274. Block 274 is initiated when a request to transfer account 106 from institution 102 to institution_2 is received by institution 102. Typically included in such a request is a transfer of client information 144 (FIG. 2) from institution_1 102 to institution_2. Process 270 then proceeds to a “Complete Pending Transactions” block 276 during which institution 102 finishes all initiated and uncompleted transactions so that information stored concerning account 106 is accurate and up-to-date at the time of the transfer.

Control then proceeds to a “Negative Balance?” block 278 during which process 270 determines whether of not account 106 has a negative balance as reflected in consolidated balance 138 (FIGS. 1 and 2). If so, then process 270 proceeds to an “Establish Credit” block 280 during which institution_2 sets up a line of credit to accommodate the negative balance. Of course, institution_2 may at this point decline to issue credit to customer_2 and, in that case, no transfer may take place. Although a possibility, the scenario of institution_2 refusing the transfer is not illustrated in FIG. 6.

Once a line of credit has been established in block 280 or process 270 has determined in block 278 that account 106 does not have a negative balance, control proceeds to an “Establish Account” block 282 during which institution_2 sets up the account to which account 106 is to be transferred. Control then proceeds to a “Transfer Account” block 284 during which process 106 transfers account 106 to the account at institution_2 established during block 282. An account transfer involves a transfer of assets and information included in components 138, 142, 150, 152, 154, 156, 158 and 160, which it should be noted include consolidated balance 138 and transaction history 142. In the alternative, institution 102 transfers only assets, consolidated balance 138 and transaction history 142 and institution recreates the remaining components from the transferred information.

Control then proceeds to a “Transfer Auto Payments” block 286 during which institution_2 sends address correction requests to originators of automatic payment or deposit requests associated with account 106. Each address correction request identifies both the old account and the new account and the corresponding institutions. Thus, automatic transactions are transferred to the new account without having to cancel one set of requests and activate another.

Control then proceeds to an “Assign Risk” block 288 during which the new institution evaluates the data transmitted with account 106 and makes their own determination of a co-sign factor and a collateral factor, if applicable, and any interest rates that may be applied to the account. Control then proceeds to a “Calculate Balance” block 290 during which institution_2 calculates a new consolidated balance 138 based upon data calculated in block 288. In order to prevent surprises, process 270 may be executed on a “faux” transfer, using the best available data prior to the execution of the actual transfer. In this manner, all parties can get a good idea of the parameters of the account transfer before the transfer actually takes place. Finally, control proceeds to an “End Transfer Account” block 299 in which process 270 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method of transferring an automatic subscriptions transaction corresponding to a third party from one financial institution to another institution, comprising:
identifying an automatic subscription transaction associated with a first account at a first financial institution;
capturing account specifics corresponding to the automatic subscription transaction;
transmitting the account specifics to a second financial institution;
identifying a second account at the second financial institution; and
notifying the third party of the account specifics, the first financial institution, the second financial institution and the second account so that the third party can redirect the automatic subscription transaction from the first account to the second account.

2. The method of claim 1, wherein the automatic subscription transaction is a deposit transaction and the first financial institution notifies the third party.

3. The method of claim 1, wherein the automatic subscription transaction is a debit transaction and the second financial institution notifies the third party.

4. The method of claim 1, wherein at least one of the financial institutions is a bank.

5. The method of claim 1, wherein the account specifics include an amount, an account holder associated with the automatic subscription transaction and the third party associated with the automatic subscription transaction.

6. The method of claim 1, wherein the transmitted account specifics are in the form of an address change.

7. The method of claim 1, wherein the first and second accounts are each integrated accounts having one of more components, each component being at any particular time either an asset or liability.

8. A system for transferring an automatic subscriptions transaction from one financial institution to another institution, comprising:
an automatic subscription transaction corresponding to a third party associated with a first account at a first financial institution;
account information corresponding to the automatic subscription transaction;
logic for transmitting the account information to a second financial institution;
a second account at the second financial institution; and
logic for notifying the third party of the account information, the first financial institution, the second financial institution and the second account so that the third party can redirect the automatic subscription transaction from the first account to the second account.

9. The system of claim 8, wherein the automatic subscription transaction is a deposit transaction and the first financial institution executes the notification logic.

10. The system of claim 8, wherein the automatic subscription transaction is a debit transaction and the second financial institution executes the notification logic.

11. The system of claim 8, wherein at least one of the financial institutions is a bank.

12. The system of claim 8, wherein the account information comprises:
an amount,
information pertaining to an account holder associated with the automatic subscription transaction; and
information pertaining to the third party associated with the automatic subscription transaction.

13. The system of claim 8, wherein the transmitted account information is in the form of an address change form.

14. The system of claim 8, wherein the first and second accounts are each integrated accounts having one of more components, each component being at any particular time either an asset or liability.

15. A computer programming product for transferring an automatic subscriptions transaction corresponding to a third party from one financial institution to another institution, comprising:
a memory;
logic, stored on the memory, for identifying an automatic subscription transaction associated with a first account at a first financial institution;
logic, stored on the memory, for capturing account specifics corresponding to the automatic subscription transaction;
logic, stored on the memory, for transmitting the account specifics to a second financial institution;
logic, stored on the memory, for identifying a second account at the second financial institution; and
logic, stored on the memory, for notifying the third party of the account specifics, the first financial institution, the second financial institution and the second account so that the third party can redirect the automatic subscription transaction from the first account to the second account.

16. The computer programming product of claim 15, wherein the automatic subscription transaction is a deposit transaction.

17. The computer programming product of claim 15, wherein the automatic subscription transaction is a debit transaction.

18. The computer programming product of claim 15, wherein at least one of the financial institutions is a bank.

19. The computer programming product of claim 15, wherein the account specifics include an amount, an account holder associated with the automatic subscription transaction and the third party associated with the automatic subscription transaction.

20. The computer programming product of claim 15, wherein the transmitted account specifics are in the form of an address change.
